(19) United States
(12) Patent Application Publication
(10) Pub. No.: US 2022/0154309 A1
(43) Pub. Date: May 19, 2022

(54) PROCESSES FOR TREATING SCRAP METAL MATERIAL

(71) Applicant: CVMR Corporation, Tornonto (CA)

(72) Inventors: Kamran M. Khozan, Toronto (CA); Nanthakumar Victor Emmanuel, Toronto (CA)

(21) Appl. No.: 17/531,310

(22) Filed: Nov. 19, 2021

Related U.S. Application Data
(60) Provisional application No. 63/115,947, filed on Nov. 19, 2020.

(51) Int. Cl. C22B 3/00; C21B 15/04; C22B 23/00; C22B 3/44

(52) U.S. Cl. CPC C22B 23/0461; C22B 3/44; C22B 23/005; C21B 15/04

(57) ABSTRACT

There is provided a process for treating particulate scrap material. The process includes emplacing the particulate scrap material and a reagent material within a calcining zone with effect that a reactive process is effected such that a calcined metal material product is obtained, and carbonylating a carbonylation precusor material with effect that a carbonylated product is obtained, wherein the carbonylation precursor material is derived from the calcined metal material product.

### CROSS REFERENCE TO RELATED APPLICATION

The present application claims priority to U.S. Provisional Application No. 63/115,947 filed on Nov. 19, 2020, which is hereby incorporated by reference.

### FIELD

The present disclosure relates to processing of scrap metal material.

### BACKGROUND

Recycling of scrap metal-comprising material is helpful for mitigating the depletion of valuable mineral resources.

### SUMMARY

In one aspect, there is provided a process for treating particulate scrap material comprising:

emplacing the particulate scrap material and a reagent material within a calcining zone with effect that a reactive process is effected such that a calcined metal material product is obtained;
wherein:
   the calcining zone is disposed at a temperature from 650 degrees Celsius to 1150 degrees Celsius;
   the scrap material includes metallic material, and the metallic material includes at least one target metal, and the at least one target metal is nickel, iron, or nickel and iron;
   wherein:
   where the scrap material incudes nickel, at least 90 weight of the total amount of nickel of the scrap material is elemental nickel, based on the total weight of the nickel of the scrap material;
   where the scrap material includes iron, at least 90 weight of the total amount of iron of the scrap material is elemental iron, based on the total weight of the iron of the scrap material; and
   carbonylating a carbonylation precusor material with effect that a carbonylated product is obtained;
   wherein:
      the carbonylation precursor material is derived from the calcined metal product.

### BRIEF DESCRIPTION OF DRAWINGS

The embodiments of the process will now be described with reference to the following accompanying drawings, in which:

FIG. 1 is a flowsheet illustrating an embodiment of the process.

### DETAILED DESCRIPTION

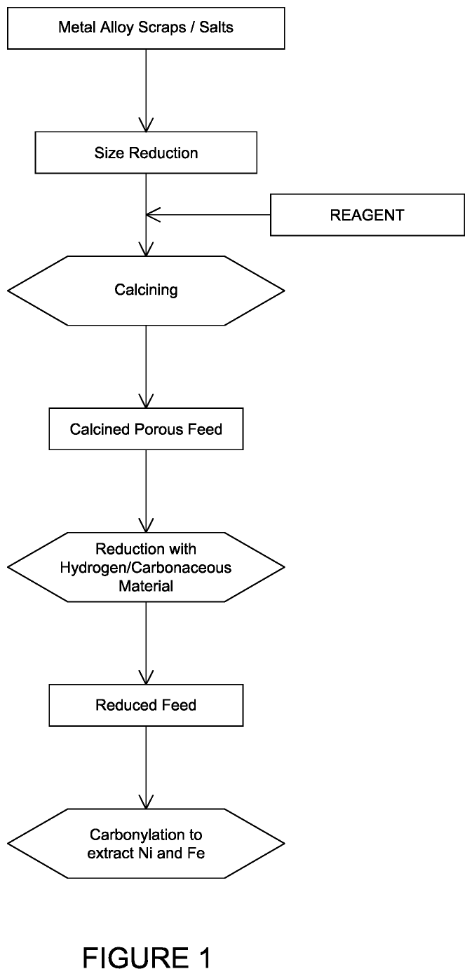

Referring to FIG. 1, a process is provided for treating scrap, metal-comprising material, wherein the scrap, metal-comprising material includes metallic material, and the metallic material includes at least one target metal, and the at least one target metal is nickel, iron, or nickel and iron.

In those embodiments where the at least one target metal includes nickel, at least 90 weight of the total amount of nickel of the scrap material is elemental nickel, based on the total weight of the nickel of the scrap material.

In those embodiments where the at least one target metal includes iron, at least 90 weight of the total amount of iron of the scrap material is elemental iron, based on the total weight of the iron of the scrap material.

In some embodiments, for example, the scrap, metal-comprising material includes at least three (3) weight percent nickel, based on the total weight of the scrap, metal-comprising material. In some embodiments, for example, the scrap, metal-comprising material includes at least six (6) weight percent nickel, based on the total weight of the scrap, metal-comprising material. In some embodiments, for example, the scrap, metal-comprising material includes from three (3) weight percent nickel, based on the total weight of the scrap, metal-comprising material, to 50 weight percent nickel, based on the total weight of the scrap, metal-comprising material.

In some embodiments, for example, scrap, metal-comprising material includes at least 20 weight percent iron, based on the total weight of the scrap, metal-comprising material. In some embodiments, for example, scrap, metal-comprising material includes from 20 weight percent iron, based on the total weight of the scrap, metal-comprising material, to 80 weight percent iron, based on the total weight of the scrap, metal-comprising material.

In some embodiments, for example, the scrap, metal-comprising material includes: (i) from three (3) weight percent nickel, based on the total weight of the scrap, metal-comprising material, to 50 weight percent nickel, based on the total weight of the scrap, metal-comprising material, and (ii) from 20 weight percent iron, based on the total weight of the scrap, metal-comprising material, to 80 weight percent iron, based on the total weight of the scrap, metal-comprising material.

In some embodiments, for example, the metallic material is in the form of an alloy.

In some of these embodiments, for example, the metallic material includes stainless steel.

In some embodiments, for example, the metallic material includes a salt of nickel.

In some embodiments, for example, the metallic material includes a salt of iron. In some embodiments, for example, the metallic material includes a salt of nickel and a salt of iron.

In some embodiments, for example, the scrap, metal comprising material is derived from an electrode of a waste battery.

In some embodiments, for example, the process includes subjecting the scrap, metal-comprising material to size reduction (such as, for example, by grinding, crushing, and/or milling) such that the scrap, metal-comprising material is a particulate material, wherein at least 90 weight % of the particulate material has a particle size of minus seven (7) mesh.

In some embodiments, for example, the particulate material and a reagent material are emplaced within a calcining zone with effect that a calcined metal material product is obtained. In some of these embodiments, the emplacement is with effect that a reactive process is effected. In some embodiments, for example, relative to the particulate material, the calcined metal material product is more porous, such that the reactive process stimulates an increase in porosity.

In some embodiments, for example, the emplacement of the calcined metal material product and the reducing agent within the reduction zone is with effect that a reactive process is effected such that a reduced metal material product is obtained. In those embodiments where the metallic material of the particulate material includes iron, in some of these embodiments, for example, the contacting with the reducing agent effects reduction of iron of an iron oxide of the calcined metal material product with effect that elemental iron is obtained. In those embodiments where the metallic material of the particulate material includes nickel, in some of these embodiments, for example, the contacting with the reducing agent effects reduction of nickel of a nickel oxide of the calcined metal material product, with effect that elemental nickel is obtained. In some embodiments, for example, the reactive process is with effect that gaseous material is released. In some embodiments, for example, the released gaseous material includes at least one of SO₂ and CO₂.

In some embodiments, for example, the emplacement includes admixing the particulate material and the reagent material, and the admixture includes from ten (10) weight percent to 50 weight percent of the reagent material, based on the total weight of the admixture.

In some embodiments, for example, the reagent material includes material selected from an alkali earth metal-comprising compound, an alkaline earth metal-comprising compound, or both of an alkali earth metal-comprising compound and an alkali earth metal-comprising compound.

In those embodiments where the reagent material includes an oxide (i.e. where the reagent material includes an alkali earth metal-comprising compound, the reagent material includes an oxide of the alkali earth metal-comprising compound, and where the reagent material includes an alkaline earth metal-comprising compound, the reagent material includes an oxide of the alkaline earth metal-comprising compound, and where the reagent material includes both of an alkali earth metal-comprising compound and an alkali earth metal-comprising compound, the reagent material includes both of an oxide of the alkali earth metal-comprising compound and an oxide of the alkali earth metal-comprising compound):
where the scrap, metal-comprising material includes from three (3) weight percent nickel, based on the total weight of the scrap, metal-comprising material, to 50 weight percent nickel, based on the total weight of the scrap, metal-comprising material, the calcined metal material product includes less than one (1) weight percent of oxides of nickel, based on the total weight of the calcined metal material product; and
where the scrap, metal-comprising material includes from 20 weight percent iron, based on the total weight of the scrap, metal-comprising material, to 80 weight percent iron, based on the total weight of the scrap, metal-comprising material, the calcined metal material product includes less than five (5) weight percent of oxides of iron, based on the total weight of the calcined metal material product.

In those embodiments where the reagent material includes a halide (i.e. where the reagent material includes an alkali earth metal-comprising compound, the reagent material includes a halide of the alkali earth metal-comprising compound, and where the reagent material includes an alkaline earth metal-comprising compound, the reagent material includes a halide of the alkaline earth metal-comprising compound, and where the reagent material includes both of an alkali earth metal-comprising compound and an alkali earth metal-comprising compound, the reagent material includes both of a halide of the alkali earth metal-comprising compound and a halide of the alkali earth metal-comprising compound):
where the scrap, metal-comprising material includes from three (3) weight percent nickel, based on the total weight of the scrap, metal-comprising material, to 50 weight percent nickel, based on the total weight of the scrap, metal-comprising material, the calcined metal material product includes less than five (5) weight percent of halides of nickel, based on the total weight of the calcined metal material product; and
where the scrap, metal-comprising material includes from 20 weight percent iron, based on the total weight of the scrap, metal-comprising material, to 80 weight percent iron, based on the total weight of the scrap, metal-comprising material, the calcined metal material product includes less than ten (10) weight percent of halides of iron, based on the total weight of the calcined metal material product.

In some embodiments, for example, the reagent material includes one or more halide-ion donating agents. In some of these embodiments, for example, the contacting is effected within a contacting zone, wherein, within the contacting zone, the ratio of [moles of halide ion of the one or more halide ion-donating agents] to [moles of the at least target metal] is between 0.5 and 15.

In some embodiments, for example, the calcining zone is disposed at a temperature of at least 650 degrees Celsius. In some embodiments, for example, the calcining zone is disposed at a temperature from 650 degrees Celsius to 1150 degrees Celsius. In some embodiments, for example, the calcining zone is disposed at atmospheric condition. In some embodiments, for example, the calcining within the calcining zone is effected in the presence of atmospheric air.

In some embodiments, for example, the calcined metal material product and a reducing agent is emplaced within a reduction zone. In some embodiments, for example, suitable reducing agents include gaseous molecular hydrogen, gaseous carbon monoxide and carbon. In some embodiments, for example, the reduction zone is disposed at a temperature from 600 degrees Celsius to 1,200 degrees Celsius (such as, for example, 650 degrees Celsius to 800 degrees Celsius), and at a pressure from one (1) to three (3) bars.

In some embodiments, for example, the reduced metal material product is contacted with gaseous hydrogen sulphide within an activation zone with effect that the surface of the reduced metal material product is activated, and with effect that an activated metal material product is obtained. In some of these embodiments, for example, the contacting is effectuated in response to emplacement of the reduced metal material product and the gaseous hydrogen sulphide within the activation zone, and the emplacement is with effect that a reactive process is effected. In some embodiments for example, the activation is such that the elemental nickel and/or elemental iron become more reactive.

In some embodiments, for example, the activated metal material product and a carbonylating agent are emplaced within a carbonylation zone with effect that a reactive process is effected such that a carbonylation zone product is obtained. In some embodiments, for example, the carbonylating agent includes carbon monoxide. In some embodiments, for example, the carbonylation zone is disposed at a pressure from 5 bar to 60 bar, and at a temperature from 80 degrees Celsius to 120 degrees Celsius.

In those embodiments where the carbonylation zone product includes nickel carbonyl and iron carbonyl, in some of these embodiments, for example, the carbonylation zone product is fractionated, with effect that a nickel-rich product and an iron-rich product are obtained. In some of these embodiments, for example, the fractionation is effected via fractional distillation. In some of these embodiments, for example, a nickel carbonyl-rich product is recovered as an overhead vapour product, and an iron carbonyl-rich product is recovered as a bottoms liquid product.

The present disclosure can be embodied in other specific forms without departing from the subject matter of the claims. The described example implementations are to be considered in all respects as being only illustrative and not restrictive. Selected features from one or more of the above-described implementations can be combined to create alternative implementations not explicitly described, features suitable for such combinations being understood within the scope of this disclosure.

All values and sub-ranges within disclosed ranges are also disclosed. Also, although the systems, devices and processes disclosed and shown herein can include a specific number of elements/components, the systems, devices and assemblies could be modified to include additional or fewer of such elements/components. For example, although any of the elements/components disclosed can be referenced as being singular, the implementations disclosed herein could be modified to include a plurality of such elements/components. The subject matter described herein intends to cover and embrace all suitable changes in technology.

1-21. (canceled)

22. A process for treating particulate scrap material comprising:
emplacing the particulate scrap material and a reagent material within a calcining zone with effect that a reactive process is effected such that a calcined metal material product is obtained;
wherein:
the scrap material includes metallic material, and the metallic material includes at least one target metal, and the at least one target metal is nickel, iron, or nickel and iron;
wherein:
where the at least one target metal includes nickel, at least 90 weight of the total amount of nickel of the scrap material is elemental nickel, based on the total weight of the nickel of the scrap material;
where the at least one target metal includes iron, at least 90 weight of the total amount of iron of the scrap material is elemental iron, based on the total weight of the iron of the scrap material; and
carbonylating a carbonylation precusor material with effect that a carbonylated product is obtained, wherein the carbonylation precursor material is derived from the calcined metal material product.

23. The process as claimed in claim 22;
wherein:
the reactive process within the calcining zone is with effect that the calcined metal material product is more porous than the particulate scrap material.

24. The process as claimed in claim 23;
wherein:
the reagent material includes a material selected from an alkali earth metal-comprising compound, an alkaline earth metal-comprising compound, or both of an alkali earth metal-comprising compound and an alkali earth metal-comprising compound.

25. The process as claimed in claim 24;
wherein:
the scrap material includes from three (3) weight percent nickel, based on the total weight of the scrap material, to 50 weight percent nickel, based on the total weight of the scrap material.

26. The process as claimed in claim 25;
wherein:
the material of the reagent material includes an oxide; and
the calcined metal material product includes less than one (1) weight percent of oxides of nickel, based on the total weight of the calcined metal material product.

27. The process as claimed in claim 25;
wherein:
the material of the reagent material includes a halide; and
the calcined metal material product includes less than five (5) weight percent of halides of nickel, based on the total weight of the calcined metal material product.

28. The process as claimed in claim 24;
wherein:
the scrap material includes from 20 weight percent iron, based on the total weight of the scrap, metal-comprising material, to 80 weight percent iron, based on the total weight of the scrap, metal-comprising material.

29. The process as claimed in claim 28;
wherein:
the material of the reagent material includes an oxide; and
the calcined metal material product includes less than five (5) weight percent of oxides of iron, based on the total weight of the calcined metal material product.

30. The process as claimed in claim 28;
wherein:
the material of the reagent material includes a halide; and
the calcined metal material product includes less than ten (10) weight percent of halides of iron, based on the total weight of the calcined metal material product.

31. The process as claimed in claim 23;
wherein:
the reagent material includes a halide ion-donating agent.

32. The process as claimed in claim 22;
further comprising:
activating the calcined metal material product to produce an activated calcined metal material product, such that the carbonylation precursor material is derived from the activated calcined metal material product.

33. The process as claimed in claim 22;
wherein:
the carbonylating includes contacting the carbonylation precursor material with a carbonylating agent within a carbonylation zone.

34. The process as claimed in claim 33;
wherein:
the carbonylating agent includes carbon monoxide; and
the carbonylation zone is disposed at a pressure from 5 bar to 60 bar, and at a temperature from 80 degrees Celsius to 120 degrees Celsius.

35. The process as claimed in claim 34, further comprising:
fractionating the carbonylated product.

36. The process as claimed in claim 35;
wherein:
the fractionating includes fractional distillation.

37. The process as claimed in claim 22;
wherein the scrap material is derived from an electrode of a waste battery.

38. The process as claimed in claim 22;
wherein the scrap material is derived from waste stainless steel.

39. The process as claimed in claim 22;
wherein:
at least 90 weight % of the particulate scrap material has a particle size of minus seven (7) mesh.

40. The process as claimed in claim 22;
wherein:
the calcining zone is disposed at a temperature from 650 degrees Celsius to 1150 degrees Celsius.

41. A process for treating particulate scrap material comprising
emplacing particulate scrap material and a reagent material within a calcining zone with effect that a reactive process is effected such that a calcined metal material product is obtained; and
carbonylating a carbonylation precusor material with effect that a carbonylated product is obtained, wherein the carbonylation precursor material is derived from the calcined metal material product.
